(19) United States
(12) Patent Application Publication
(10) Pub. No.: US 2019/0143718 A1
(43) Pub. Date: May 16, 2019

(54) UNIT FOR THERMOSETTING PRINTED FABRICS

(71) Applicant: ATPCOLOR S.r.l., Senago (Milano) (IT)

(72) Inventor: Roberto Maria MARTELLONO, Cerano (Novara) (IT)

(21) Appl. No.: 16/164,337

(22) Filed: Oct. 18, 2018

(30) Foreign Application Priority Data
Nov. 15, 2017 (IT) 102017000130581

(51) Int. Cl. B41J 11/00; B41J 3/407

(52) U.S. Cl. CPC B41J 11/0045; B41J 3/4078; B41J 11/002

(57) ABSTRACT

A unit for thermosetting printed fabrics, comprising: a heated roller rotatable about a rotation axis and having a cylindrical outer surface, at least one fabric guiding element having an inner wall facing the cylindrical outer surface of the heated roller and defining a gap with the cylindrical outer surface of the heated roller for passing the fabric, wherein said at least one fabric guiding element has a fume suction chamber connected to a suction device, and wherein said inner wall has a plurality of holes communicating with said suction chamber.

### CROSS-REFERENCE TO RELATED APPLICATIONS

This application claims benefit of Italian patent application number 102017000130581, filed Nov. 15, 2017 which is herein incorporated by reference.

### BACKGROUND OF THE INVENTION

### Field of the Invention

The present invention relates in general to textile printers for digital printing on fabrics.

More particularly, the invention relates to a unit for thermosetting the colors (inks) onto the fabrics.

### Description of Prior Art

In digital printing on fabrics, thermosetting of the inks on the printed fabric may be necessary. In these cases, it is common to use a thermosetting unit comprising a heated roller, rotatable about a rotation axis and having a cylindrical outer surface on which the moving fabric is wound with a predetermined winding angle. The thermosetting unit can be integrated into the textile printer (in-line thermosetting) or it can be a stand-alone unit separate from the textile printer.

The working temperature on the outer surface of the heated roller in contact with the fabric can be in the order of 100-200° C. During the passage of the printed fabric onto the heated roller, fumes are formed due to evaporation of the volatile substances contained in the inks. Systems for extracting fumes that develop during the thermosetting process can be provided in order to obtain a better print quality.

U.S. Pat. No. 3,440,735 describes an apparatus for heat treatment of sheet materials comprising a series of rollers around which the sheet to be treated passes. Some of said rollers have perforated outer surfaces for extracting fumes.

### SUMMARY OF THE INVENTION

The present invention aims to provide a thermosetting unit for thermosetting printed fabrics, equipped with an improved fume extraction system that allows a better and more defined printing quality to be obtained.

According to the present invention, this object is achieved by a thermosetting unit having the characteristics disclosed herein.

The claims form an integral part of the disclosure provided here in relation to the invention.

### BRIEF DESCRIPTION OF THE DRAWINGS

The present invention will now be described in detail with reference to the attached drawings, given purely by way of non-limiting example, wherein:

FIG. 1 is a schematic side view of a textile printer comprising a thermosetting unit according to the present invention.

FIG. 2 is a perspective view of the thermosetting unit indicated by the arrow II in FIG. 1.

FIG. 3 is an exploded perspective view of the thermosetting unit of FIG. 2.

FIG. 4 is a perspective view of a fabric guiding element indicated by the arrow IV in FIG. 3.

FIG. 5 is a cross-section along the line V-V of FIG. 4.

It will be appreciated that, for clarity and simplicity of illustration, the various figures may not be reproduced on the same scale.

### DETAILED DESCRIPTION

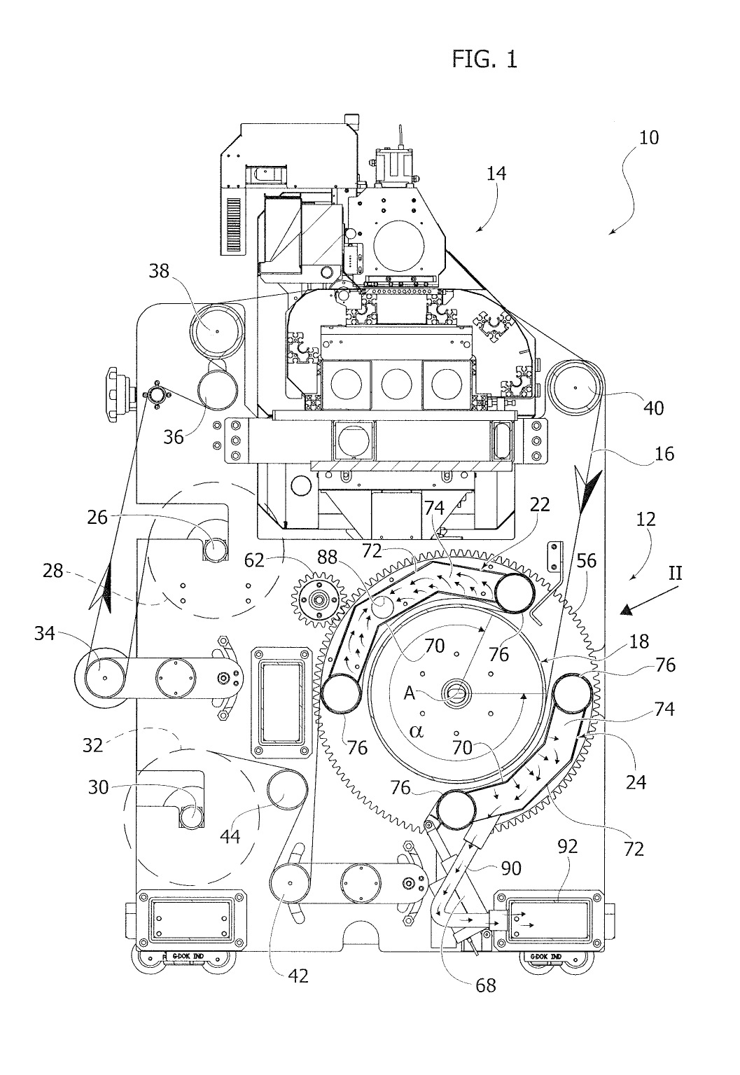

With reference to FIG. 1, numeral 10 indicates a textile printer comprising a thermosetting unit 12 according to the present invention. The textile printer 10 comprises a printing unit 14 for digital printing onto a moving fabric 16. The thermosetting unit 12 comprises a heated roller 18 rotatable about a horizontal rotation axis A. The heated roller 18 has a cylindrical outer surface on which the moving fabric 16 wraps with a wrapping angle α.

The thermosetting unit 12 comprises at least one fabric guiding element for guiding the fabric 16 in contact with the cylindrical outer surface of the heated roller 18. In the illustrated example, the thermosetting unit 12 comprises two fabric guiding elements 22, 24 facing respective portions of the outer cylindrical surface of the heated roller 18. The fabric guiding elements 22, 24 have respective concave inner surfaces facing the heated roller 18 which define respective gaps with respect to the cylindrical outer surface of the heated roller 18 and through which the fabric 16 passes in contact with the heated outer surface of the heated roller 18.

As the fabric 16 passes around the heated roller 18, the thermosetting of the inks onto the fabric 16 is carried out due to the heat transferred to the fabric by the heated roller 18, whose outer surface is heated to a temperature that can reach up to 200° C.

The textile printer 10 comprises a first reel 26 on which a bobbin 28 of fabric to be printed is rotatably mounted and a second reel 30 on which the printed fabric wraps downstream of the thermosetting unit 12, forming a bobbin 32. The textile printer 10 comprises a plurality of rollers 34, 36, 38, 40, 42, 44 which feed and guide the fabric 16 in its movement through the printing head 14 and through the thermosetting unit 12.

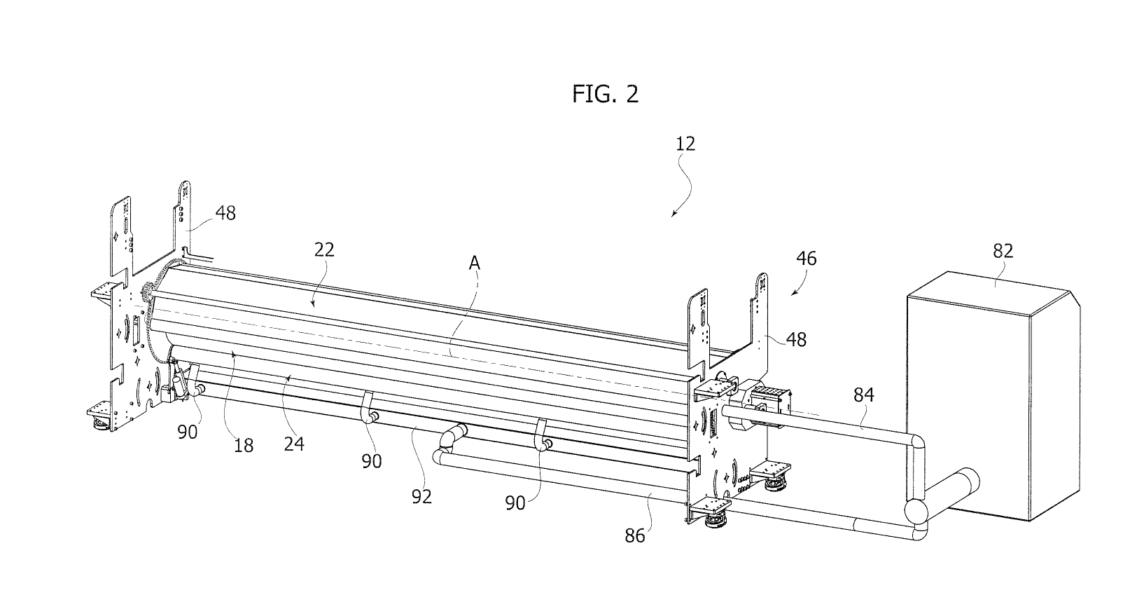

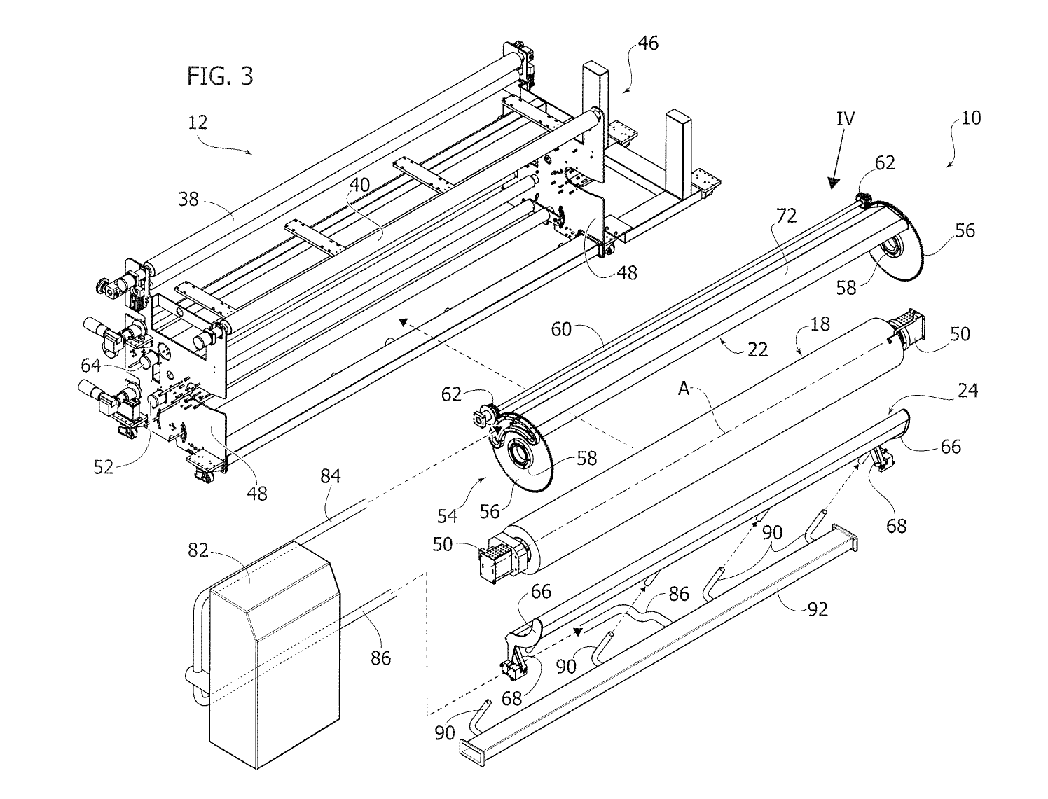

With reference to FIGS. 2 and 3, the thermosetting unit 12 comprises a stationary supporting structure 46 including two sides 48 formed by two vertical walls parallel to each other. The heated roller 18 is carried in a rotatable manner about the rotation axis A by two side supports 50 fixed to the sides 48 of the stationary supporting structure 46. The heated roller 18 is rotated about the axis A by means of an electric motor 52, which can be carried by one of the sides 48 of the stationary supporting structure 46 (FIG. 3).

As shown in particular in FIG. 3, the first guiding element 22 can be carried by an adjusting device 54 rotatable about the rotation axis A independently of the heated roller 18, which allows adjustment of the angular position of the first guiding element 22 with respect to the heated roller 18. The adjusting device 54 is described in detail in a contemporary patent application by the same Applicant. The adjusting device 54 may comprise two gears 56 provided with respective bearings 58 which rotatably engage the supports 50 of the heated roller 18. The gears 56 can rotate about the axis A independently of the heated roller 18. The first guiding element 22 can be fixed at its opposite ends to the gears 56. The heated roller 18 can be located between the two gears 56.

The adjusting device 54 comprises a shaft 60 parallel to the rotation axis A, rotatably carried about its own axis by the sides 48 of the stationary supporting structure 46. Two toothed sprockets 62 are fixed on the shaft 60, which engage with the respective gears 56. The shaft 60 is rotated about its axis by a motor 64 carried by one of the sides 48 of the stationary supporting structure 46. The motor 64, by means of the shaft 60 and the toothed pinions 62, can control the joint rotation of the two gears 56 about the axis A and can therefore adjust the angular position of the first guiding device 22 about the heated roller 18, to regulate the wrapping angle α (FIG. 1) of the fabric 16 about the heated roller 18.

In the case in which adjustment of the contact angle between the fabric and the heated roller 18 is not required, the first guiding element 22 can be in a fixed position with respect to the stationary supporting structure 46.

With reference to FIG. 3, the second guiding element 24 can be fixed to two levers 66 located at opposite ends of the guiding element and articulated to the stationary supporting structure 46 about a common axis parallel to the rotation axis A. The levers 66 can be associated with respective linear actuators 68 operable to control an oscillation movement of the second guiding element 24 between an operative position in which the second guiding element 24 is placed next to the heated roller 18 and an inoperative position in which the second guiding element 24 is moved away from the heated roller 18.

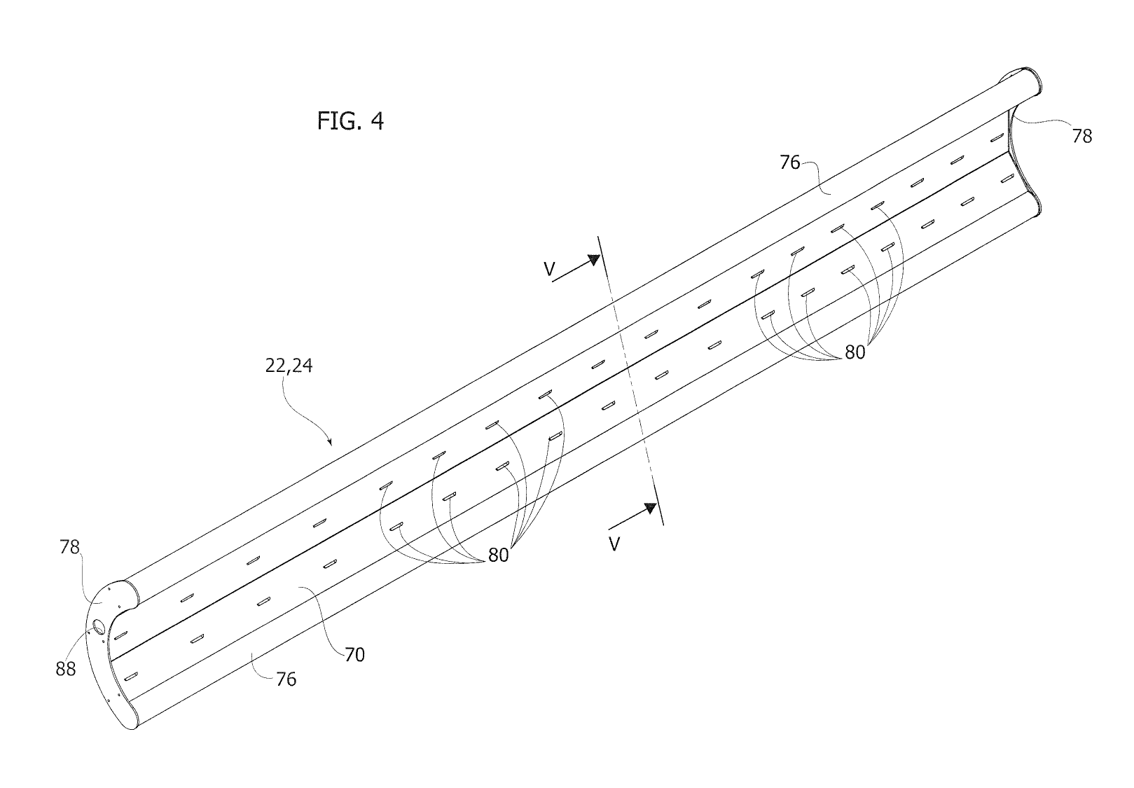

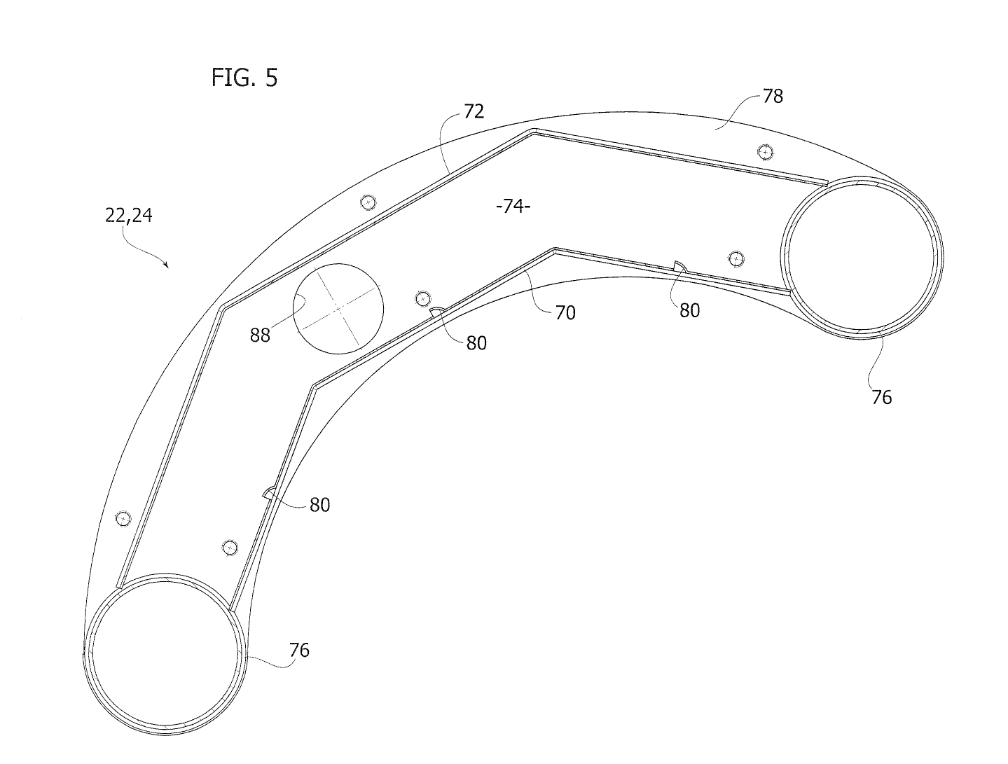

With reference to FIGS. 4 and 5, each of the two guiding elements 22, 24 has the shape of a wing profile with a concave inner wall 70 and a convex outer wall 72. The inner wall 70 and the outer wall 72 are spaced apart so as to define an empty space therebetween forming a suction chamber 74, the walls 70, 72 may be formed of bent sheet metal. Each guiding element 22, 24 may comprise two tubular elements 76 parallel to each other and parallel to the rotation axis A, which close the suction chamber 74 along opposite longitudinal edges of the guiding elements 22, 24. The opposite front ends of the guiding elements 22, 24 can be closed by end plates 78. The inner wall 70 of the guiding elements 22, 24 comprises a plurality of holes 80 which communicate with the suction chamber 74 and results in communication of the suction chamber 74 with the outside.

With reference to FIGS. 2, 3 and 4, the thermosetting unit 12 comprises a suction device 82 connected by means of tubes 84, 86 to the suction chambers 74 of the guiding elements 22, 24. The suction chamber 74 of the first guiding element 22 can be connected to the first suction pipe 84 by means of a hole 88 formed in one of the end plates 78. The first suction pipe 84 may comprise at least one flexible part to allow the adjustment movement of the first guiding element 22 about the axis A. The second guiding element 24 can be connected to the second fume suction tube 86 by means of a plurality of flexible tubes 90 connected to a manifold 92, in turn connected to the second fume suction tube 86.

With reference to FIG. 1, during operation, the suction device 82 generates a vacuum in the suction chambers 74 of the guiding elements 22, 24. The fumes generated around the heated roller 18 due to evaporation of the volatile substances contained in the inks are drawn into the gaps formed between the outer cylindrical surface of the heated roller 18 and the inner surfaces 70 of the guiding elements 22, 24. In FIG. 1, the arrows inside the guiding elements 22, 24 schematically indicate the suction path of the fumes inside the suction chambers 74.

Extraction of the fumes carried out in the gap formed between the fabric guiding elements 22, 24 and the outer surface of the heated roller 18 allows better extraction of the fumes and allows a better and more defined print quality to be obtained. The fabric guiding elements 22, 24 have the dual function of guiding the fabric 16 in contact with the outer cylindrical surface of the heated roller 18 and fume extraction. Thus, separate elements for fume extraction are avoided. The fume extraction system according to the present invention can be easily integrated with the adjusting device, which allows adjustment of the contact angle a of the fabric around the heated roller 18.

The thermosetting unit can be integrated into the textile printer 10 as illustrated in FIG. 1 or it can be a stand-alone unit separate from the textile printer.

Of course, without prejudice to the principle of the invention, the details of construction and the embodiments may be widely varied with respect to those described and illustrated, without thereby departing from the scope of the invention as defined by the claims that follow.

1. A unit for thermosetting printed fabrics, comprising:
a heated roller rotatable about a rotation axis and having a cylindrical outer surface,
at least one fabric guiding element having a fume suction chamber connected to a suction device,
wherein said at least one fabric guiding element has a concave inner wall facing the cylindrical outer surface of the heated roller and defining a gap with the cylindrical outer surface of the heated roller for passing the fabric, and in that said concave inner wall has a plurality of holes that communicate with said suction chamber.

2. A unit according to claim 1, wherein said suction chamber is delimited by said inner wall and by an outer wall.

3. A unit according to claim 1, wherein said at least one fabric guiding element comprises two tubular elements parallel to said rotation axis which delimit said suction chamber along respective longitudinal edges of said fabric guiding element.

4. A unit according to claim 1, comprising a first fabric guiding element and a second fabric guiding element facing respective portions of said cylindrical outer surface of the heated roller.

5. A unit according to claim 4, wherein the first guiding element is carried by an adjusting device rotatable about said rotation axis independently of the heated roller to adjust the angular position of said fabric guiding element about said rotation axis.

6. A unit according to claim 4, wherein said second fabric guiding element is articulated to a stationary supporting structure about an axis parallel to said rotation axis and movable between an operative position in which the inner wall of the fabric guiding element is placed next to the cylindrical outer surface of the heated roller and an inoperative position in which the inner wall of the fabric guiding element is moved away from the cylindrical outer surface of the heated roller.

7. A textile printer comprising a thermosetting unit according to claim 1.
